(19) United States
(12) Patent Application Publication
(10) Pub. No.: US 2008/0320146 A1
(43) Pub. Date: Dec. 25, 2008

(54) Establishing interaction between a process and a server process

(75) Inventors: Philo Norlund, Seattle, WA (US); John R. Durant, Duvall, WA (US); Nikhil Khandelwal, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,013

(22) Filed: Jun. 21, 2007

(51) Int. Cl. G06F 15/16

(52) U.S. Cl. 709/227

(57) ABSTRACT

A method for establishing interaction between a process and a server process. In one implementation, a request may be sent to a server. The request may have a pointer and a registration for an object. The object may be designated to receive responses from the server. The object may receive the pointer and an indication that the server has instantiated a server process. The process may then interact with the server process.

### BACKGROUND

Today computing systems may typically include two or more processes that interact with each other. A common scenario may be for a controlling process to interact with to a server process. A server may be defined as an application program that accepts connections for the purpose of servicing requests and sending back responses. A process may be defined as an instance of a computer program that is being executed

When a controlling process makes a request to a server, the server may instantiate, or create an instance of, a worker process to service the request. A server may instantiate multiple worker processes to service multiple requests from one or more controlling processes. Each worker process may be referred to as a server process. Before a controlling process interacts with a server process, the controlling process may first make a request that causes the server to instantiate the server process and, second, receive notification that the server process has been instantiated. Attempting to interact before the server process has been instantiated may prevent the controlling process from interacting successfully. Therefore, receiving notification that the server process has been instantiated may be crucial to the success of the interaction. However, communication between the controlling process and the server process may be difficult to manage. The controlling process may have a requirement that a pre-determined thread of execution perform the interaction. However, when the server process responds to the controlling process, the response may be returned on a thread other than the pre-determined thread of the controlling process. The response of the server process may need to be communicated across thread boundaries to the pre-determined thread.

### SUMMARY

Described herein are implementations of various techniques for establishing interaction between a controlling process and a server process. In one implementation, a controlling process may send a request to a server. The request may include a pointer that has been marshaled to a controlling object within the process. The pointer may include information about the controlling object such as its address, pre-determined thread identifier and the like. The request may also register an object designated to receive responses from the server.

In response to receiving a request, the server may instantiate a server process to service the request. The server may then send a response to the object designated to receive responses. Such response may be used to indicate that the server has instantiated the server process and include the pointer marshaled to the controlling object. The object designated to receive responses from the server may unmarshal the pointer to the controlling object and send a notification to the controlling object that the server process has been instantiated. The notification may be sent to the controlling object on the pre-determined thread identified in the marshaled pointer. The controlling object may then interact with the server process.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a flow diagram of a method for establishing interaction between a process and a server process in accordance with implementations of various techniques described herein.

FIG. 3 illustrates a schematic diagram of the method for establishing interaction between a process and a server process that corresponds to the flow diagram illustrated in FIG. 2 in accordance with implementations of various techniques described herein.

### DETAILED DESCRIPTION

As described above, establishing interaction between a controlling process and a server process may require that the controlling process receive notification that the server process has been instantiated before an interaction attempt is made. For the controlling process to receive notification from the server process, the response of the server process may need to be communicated across thread boundaries to go back to the controlling process on the pre-determined thread. Described herein are implementations of various techniques for a process to deterministically interact with a server process. In one implementation, an interaction module may manage establishing interaction between a controlling process and a server process. In one implementation, a controlling process may marshal a pointer to a controlling object. Marshaling a pointer may be defined as packaging an object's address and thread identifier for later reference. The controlling object may be a part of the controlling process that is assigned to interact with another process. The controlling process may send a request to a server and include the marshaled pointer. The controlling process may also register an object to receive responses from the server. In one implementation, such object may be an asynchronous callback function.

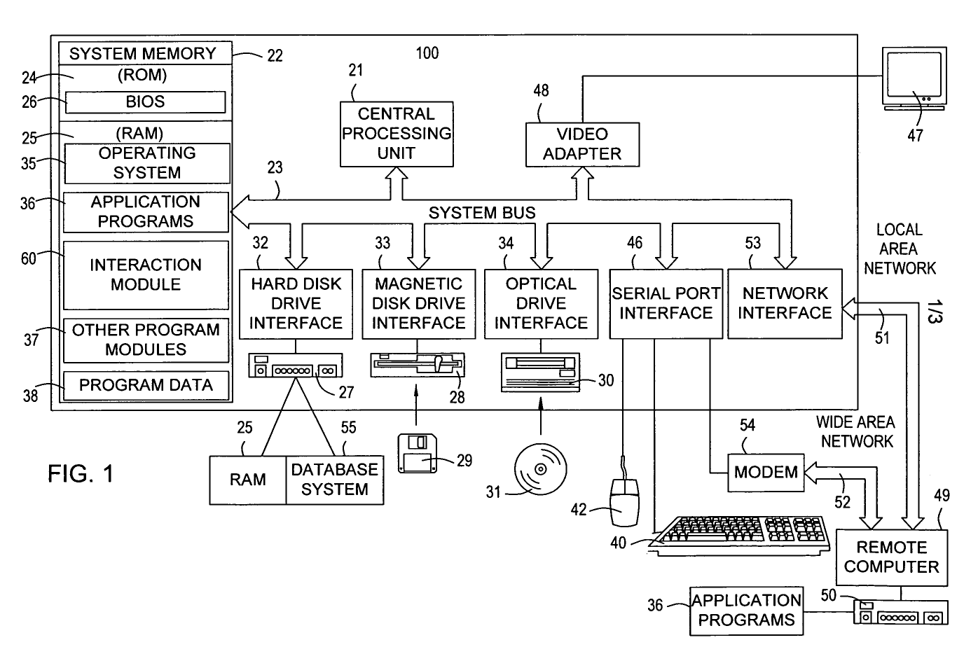

The server may then instantiate a server process. The server may then send a response to the asynchronous callback function that indicates that the server process has been instantiated. The server may include the marshaled pointer in the response so the asynchronous callback function may properly route the response to the controlling object. The response from the server may return to the asynchronous callback function on a thread other than the pre-determined thread needed to communicate with the controlling object. The asynchronous callback function may then unmarshal the marshaled pointer to locate the controlling object. The asynchronous callback function may then notify the controlling object that the server process has been instantiated by calling the controlling object on the pre-determined thread identified in the marshaled pointer. The controlling object may then interact with the server process. One or more implementations of various techniques for establishing interaction between a process and a server process are described in more detail with reference to FIGS. 1-3 in the following paragraphs.

Implementations of various techniques described herein may be operational with numerous general purpose or special purpose computing system environments or configurations. Examples of well known computing systems, environments, and/or configurations that may be suitable for use with the various techniques described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various techniques described herein may be implemented in the general context of computer-executable instructions, such as program modules, being executed by a computer. Generally, program modules include routines, programs, objects, components, data structures, etc. that perform particular tasks or implement particular abstract data types. The various techniques described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various techniques described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

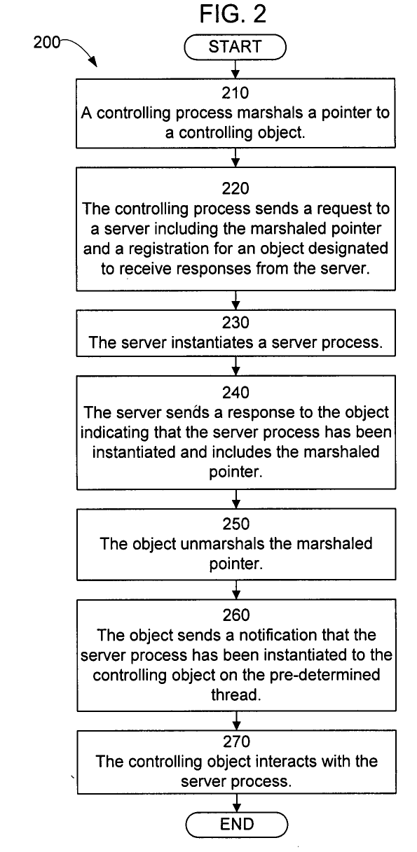

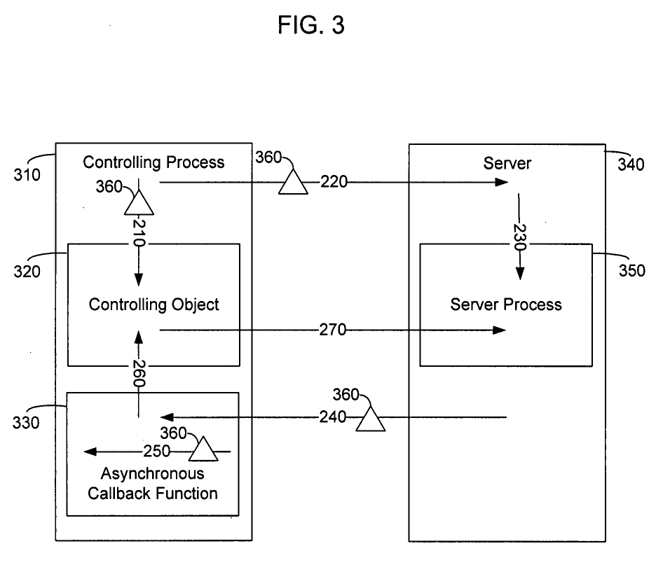

A number of program modules may be stored on the hard disk, magnetic disk 29, optical disk 31, ROM 24 or RAM 25, including an operating system 35, one or more application programs 36, an interaction module 60, other program modules 37, program data 38 and a database system 55. The operating system 35 may be any suitable operating system that may control the operation of a networked personal or server computer, such as Windows® XP, Mac OS® X, Unix-variants (e.g., Linux® and BSD®), and the like. The interaction module 60 will be described in more detail with reference to FIGS. 2-3 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various techniques described herein may be implemented in connection with hardware, software or a combination of both. Thus, various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow diagram of a method 200 for establishing interaction between a process and a server process in accordance with implementations of various techniques described herein. It should be understood that while the operational flow diagram of the method 200 indicates a particular order of execution of the operations, in some implementations, the operations might be executed in a different order. FIG. 3 illustrates a schematic diagram of the method 200 for establishing interaction between a process and a server process that corresponds to the flow diagram illustrated in FIG. 2 in accordance with implementations of various techniques described herein. In one implementation, an interaction module 60 may manage the method 200 for establishing interaction between a process and a server process.

At step 210, a controlling process 310 may marshal a pointer 360 for a controlling object 320. Marshaling may be defined as a technique of packaging an object's address and thread identifier to facilitate communication between objects running in different contexts. A pointer may be defined as an address. The controlling process 310, which intends to interact with a server 340, may have a controlling object 320 responsible for interacting with a server 340. In FIG. 3, the controlling process 310 marshals a pointer 360 to the controlling object 320, as shown by arrow 210.

At step 220, the controlling process 310 may send a request to the server 340 including the marshaled pointer 360 and a registration for an object designated to receive responses from the server. The request to the server 340 may be any request that causes the server process 350 to be instantiated. The controlling process 310 may include the marshaled pointer 360 with the controlling object's 320 address and pre-determined thread identifier. The server 340 may pass the marshaled pointer 360 back in subsequent responses.

The controlling process 310 may also register with the server an object designated to receive responses from the server 340. In one implementation, the object may be an asynchronous callback function 330. The controlling process 310 may register the asynchronous callback function 330 by sending the server 340 another pointer, which may contain the address of the asynchronous callback function 330. It should be noted that the pointer sent by the controlling process 310 to register the asynchronous callback function 330 is not the marshaled pointer of step 210. In FIG. 3, the controlling process 310 sends the request to the server 340 including the marshaled pointer 360 and a registration for the asynchronous callback function 330, as illustrated by arrow 220.

At step 230, the server 340 may instantiate a server process 350. The server process 350 may be a worker process instantiated to service the request of step 220 made by the controlling process 310. In FIG. 3, the server 340 instantiates the server process 350, as illustrated by arrow 230.

At step 240, the server 340 may send a response to the asynchronous callback function 330 that includes the marshaled pointer 360 and an indication that the server process 350 has been instantiated. The marshaled pointer 360 may be the marshaled pointer 360 passed to the server 340 from the controlling process 310 at step 220. Because the server 340 may be a loosely-controlled, multi-threaded process, the response from the server 340 may arrive at the asynchronous callback function 330 on a thread other than the pre-determined thread needed to communicate with the controlling object 320. It should be noted that, because multiple controlling objects 320 may utilize a single asynchronous callback function 330, it may be necessary for the server 340 to include a marshaled pointer 360 with each communication such that the asynchronous callback function 330 may route each communication to the proper controlling object 320. In FIG. 3, the server 340 sends an indication that the server process 350 has been instantiated and the marshaled pointer 360 to the asynchronous callback function 330 as illustrated by arrow 240.

At step 250, the asynchronous callback function 330 may unmarshal the marshaled pointer 360. Unmarshaling the marshaled pointer 360 may include reading the information packaged at step 210. The marshaled pointer 360 may contain the address and pre-determined thread identifier of the controlling object 320. In FIG. 3, the asynchronous callback function 330 unmarshals the marshaled pointer 360, as illustrated by arrow 250.

At step 260, the asynchronous callback function 330 may send a notification that the server process 350 has been instantiated to the controlling object 320. The asynchronous callback function 330 may use the information from the marshaled pointer 360 to send the notification to the controlling object 320 on the pre-determined thread. In FIG. 3, the asynchronous callback function 330 sends the notification to the controlling object 320, as illustrated by arrow 260.

At step 270, the controlling object 320 may interact with the server process 350. Interaction may include attaching, examining, controlling, killing and the like. In FIG. 3, the controlling object 320 interacts with the server process 350, as illustrated by arrow 270.

It should be noted that the controlling process 310 may be running on a computer system 100. The server process 350 may be running on the same computer system 100 or on a remote computer 49. In one implementation, the asynchronous callback function 330 may receive more than one response from the server 340 regarding the instantiation of the server process 350. This may require that the marshaled pointer 360 be unmarshaled more than one time. Various methods for marshaling a pointer may be used at step 210 to allow the marshaled pointer 360 to be unmarshaled multiple times.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for establishing interaction between a process and a server process comprising:
sending a request to a server, the request having a pointer and a registration for an object, the object being designated to receive responses from the server;
receiving at the object the pointer and an indication that the server has instantiated a server process; and
interacting with the server process.

2. The method of claim 1, wherein the object is an asynchronous callback function.

3. The method of claim 1, further comprising unmarshaling the pointer at the object.

4. The method of claim 1, further comprising marshaling the pointer to a controlling object.

5. The method of claim 4, further comprising forwarding a notification that the server has instantiated a server process to the controlling object.

6. The method of claim 4, further comprising:
unmarshaling the pointer at the object; and
forwarding a notification that the server has instantiated a server process to the controlling object using information contained in the unmarshaled pointer.

7. The method of claim 4, wherein the pointer comprises an address and a pre-determined thread identifier of the controlling object.

8. The method of claim 7, further comprising sending a notification to the controlling object using the pre-determined thread identifier.

9. A computer system, comprising:
a processor; and
a memory comprising program instructions executable by the processor to:
send a request to a server to instantiate a server process;
receive a response from the server process via an asynchronous callback function; and
interact with the server process.

10. The computer system of claim 9, wherein the memory further comprises program instructions executable by the processor to marshal a pointer to a controlling object.

11. The computer system of claim 10, wherein the pointer comprises an address and a pre-determined thread identifier of the controlling object.

12. The computer system of claim 11, wherein the asynchronous callback function receives the response from the server on a thread other than a pre-determined thread indicated by the pre-determined thread identifier of the controlling object.

13. The computer system of claim 11, wherein the memory further comprises program instructions executable by the processor to unmarshal the pointer at the asynchronous callback function.

14. The computer system of claim 12, wherein the memory further comprises program instructions executable by the processor to send a notification to the controlling object on the pre-determined thread.

15. A computer-readable medium having stored thereon computer-executable instructions which, when executed by a computer, cause the computer to:
marshal a pointer to a controlling object;
send a request to a server, the request having the pointer;
receive an indication that the server has instantiated a server process and the pointer;
send a notification that the server has instantiated the server process to the controlling object; and
interact with the server process.

16. The computer-readable medium of claim 15, further comprising computer-executable instructions which, when executed by a computer, cause the computer to register an object with the server, the object being designated to receive responses from the server.

17. The computer-readable medium of claim 16, further comprising computer-executable instructions which, when executed by a computer, cause the computer to unmarshal the pointer at the object.

18. The computer-readable medium of claim 16, wherein the object is an asynchronous callback function.

19. The computer-readable medium of claim 15, wherein the pointer comprises an address and a pre-determined thread identifier of the controlling object.

20. The computer-readable medium of claim 15, further comprising sending the notification to the controlling object using a pre-determined thread indicated by the predetermined thread identifier of the controlling object.
